(19) United States
(12) Patent Application Publication
(10) Pub. No.: US 2018/0307592 A1
(43) Pub. Date: Oct. 25, 2018

(54) METHOD, APPARATUS AND SYSTEM FOR TASK AUTOMATION OF COMPUTER OPERATIONS BASED ON VISUAL FLOWCHART SCRIPT DESIGN AND IMAGE/TEXT RECOGNITION

(71) Applicant: LEAPWORK A/S, Frederiksberg (DK)

(72) Inventors: Claus Topholt, Holte (DK); Christian Brink Frederiksen, Virum (DK)

(73) Assignee: Leapwork A/S, Frederiksberg (DK)

(21) Appl. No.: 15/769,256

(22) PCT Filed: Apr. 29, 2016
(86) PCT No.: PCT/EP2016/059689

§ 371 Date: Apr. 18, 2018

(30) Foreign Application Priority Data
Oct. 19, 2015 (SE) 1551345-0
Oct. 19, 2015 (SE) 1551346-8

(51) Int. Cl. G06F 11/36

(52) U.S. Cl. CPC G06F 11/3684; G06F 11/3688; G06F 11/3664; G06F 11/3692

(57) ABSTRACT

A computing apparatus comprising a processor arrangement and a memory, wherein said processor arrangement is configured to: present a plurality of process blocks for selection; receive a first selection of at least one of said plurality of process blocks and place a representation of said first selected at least one of said plurality of process blocks on a virtual canvas, wherein said first selected at least one of said plurality of process blocks is associated with a first functionality; receive a second selection of at least one of said plurality of process blocks and place a representation of said second selected at least one of said plurality of process blocks on a canvas, wherein said second selected at least one of said plurality of process blocks is associated with a second functionality; receive an indication of a process flow order between the first and second selection of at least one of said plurality of process blocks, and indicate the order graphically on the canvas; and automatically generate computer readable instructions comprising instructions to execute the first functionality associated with the first selected at least one of said plurality of process blocks and the second functionality associated with the second selected at least one of said plurality of process blocks in the order as indicated by the indication of said process flow order, thereby providing a case logic to be executed, which case logic is comprised in the computer readable instructions, wherein at least one of said first and second functionalities is associated with a function of finding an associated graphical object by capturing a screen and performing image analysis (IR/OCR) on the screen capture to find the associated graphical object.

### TECHNICAL FIELD

This invention relates to a method, an apparatus and a system for performing automated task execution, and in particular to a method, an apparatus and a system for performing automated test execution.

### BACKGROUND

Computers are nowadays used in virtually all technical aspects of society. The operations of a computer are defined by different computer programs. Computer programs may be provided at different levels of a hierarchical structure ranging from, for instance, hardware, firmware, bios, operating system and drivers, to programming libraries, programming interfaces and application programs. The term computer software, or shortly software, will generally be used in this document to represent a piece of computer program, written in any programming language or with any programming tool, expressed in any form such as machine code, assembly code, source code or object code, and provided at any hierarchical level, without limitation.

It is typically important to verify that computer software works according to plan and without malfunctions, also known as bugs. Hence, software testing is one of the key processes in software development, accounting to a substantial part of the development resources. During the early development phase, i.e. before the software is launched to the intended users, testing is complex but to some extent manageable since it involves a limited number of people.

However, even if a software is tested carefully during the early development phase, the software might contain bugs which are difficult to detect at the time but only subsequently, e.g. during late development phase (beta versions) or even after commercial launch. This is so for instance because the behaviors of end users, and/or the nature of the computer environment in which the software finally operates, cannot be fully predicted. Bugs are typically extremely costly to fix after the launch of software. There is hence a need among software developers and other related interest groups for a proactive approach to continuously ensure quality of software and minimize the occurrence of bugs.

### SUMMARY

Test automation tools are provided to address the problems above. Hence, automation of software testing is an example of task automation of computer operations as described in this document. The present inventors have however identified a number of shortcomings with existing test automation tools.

One understanding by the present inventors is that software testers are often not computer programmers. Still, existing test automation tools require extensive programming skills to create the test cases to be performed.

Another understanding by the present inventors is that in order for a functional test to produce reliable results, the software must be run in its entirety, and without modification, in the actual target device of the test (e.g. personal Windows computer, personal OS X computer, mobile iOS device, mobile Android device, various web browsers, etc). Many existing test automation tools require modification of the software, modification of the target device, or the use of simulated devices.

It is accordingly an object of the inventive efforts disclosed in the present patent application to offer improvements in the technical field of test automation tools, and to provide one or more methods, devices, systems, etc, for automated testing of computer operations which solve, eliminate, alleviate, mitigate or reduce one or more of the problems referred to above.

Accordingly, automated testing of computer operations is provided which is based on
definition of test logic of a test case on, by or from a computer (also referred to as Test Runner, or computer A),
execution of the test logic of the test case on a computer (also referred to as System Under Test, or computer B),
image and/or text recognition of objects appearing in the UI of the remote computer when the test logic is executed.

The inventors have realized, after inventive and insightful reasoning, that by allowing the system to be tested to take complete control of the test logic—as opposed to receiving command after command for executing the test logic step by step—the system's integrity is protected. This also provides for a reduced bandwidth as it reduces the times communication need be effected between the automation controller and the system under test to when the case is initialized and when it is finished.

It should be noted that remote is taken relative the executing virtual machine or application. Should more than one actor (Studio, Controller, Agent) be executed on the same physical device, the user interface would be regarded as remote if belonging to a different application or virtual machine.

The inventors have also realized that a visual design tool that is based on the logical flow of a case may be used beneficially for designing test cases and also for other task that need be automated—especially when using image analysis such as image recognition and/or text recognition, as the actual text or image presented will be more or less the same regardless of its position, font, size or exact coloring, and especially of the underlying operating system and other related system settings, which renders a test case thusly designed indifferent to different platforms.

According to one aspect of the teachings herein, in order to reduce, overcome or at least mitigate the problems listed above, there is provided a computing apparatus comprising a processor arrangement and a memory, wherein said processor arrangement is configured to: present a plurality of process blocks for selection; receive a first selection of at least one of said plurality of process blocks and place a representation of said first selected at least one of said plurality of process blocks on a virtual canvas, wherein said first selected at least one of said plurality of process blocks is associated with a first functionality; receive a second selection of at least one of said plurality of process blocks and place a representation of said second selected at least one of said plurality of process blocks on a canvas, wherein said second selected at least one of said plurality of process blocks is associated with a second functionality; receive an indication of a process flow order between the first and second selection of at least one of said plurality of process blocks, and indicate the order graphically on the canvas; and automatically generate computer readable instructions comprising instructions to execute the first functionality associated with the first selected at least one of said plurality of process blocks and the second functionality associated with the second selected at least one of said plurality of process blocks in the order as indicated by the indication of said process flow order, thereby providing a case logic to be executed, which case logic is comprised in the computer readable instructions, wherein at least one of said first and second functionalities is associated with a function of finding an associated graphical object by capturing a screen and performing image analysis (IR/OCR) on the screen capture to find the associated graphical object.

According to one aspect of the teachings herein, in order to reduce, overcome or at least mitigate the problems listed above, there is provided a method for designing a case logic to be executed, wherein said method comprises: presenting a plurality of process blocks for selection; receiving a first selection of at least one of said plurality of process blocks and place a representation of said first selected at least one of said plurality of process blocks on a virtual canvas, wherein said first selected at least one of said plurality of process blocks is associated with a first functionality; receiving a second selection of at least one of said plurality of process blocks and place a representation of said second selected at least one of said plurality of process blocks on a canvas, wherein said second selected at least one of said plurality of process blocks is associated with a second functionality; receiving an indication of a process flow order between the first and second selection of at least one of said plurality of process blocks, and indicate the order graphically on the canvas; and automatically generating computer readable instructions comprising instructions to execute the first functionality associated with the first selected at least one of said plurality of process blocks and the second functionality associated with the second selected at least one of said plurality of process blocks in the order as indicated by the indication of said process flow order, thereby providing a case logic to be executed, which case logic is comprised in the computer readable instructions, wherein at least one of said first and second functionalities is associated with a function of finding an associated graphical object by capturing a screen and performing image analysis (IR/OCR) on the screen capture to find the associated graphical object.

According to one aspect of the teachings herein, in order to reduce, overcome or at least mitigate the problems listed above, there is provided a computing apparatus comprising a processor arrangement and a memory, wherein said processor arrangement is configured to receive a case logic as provided according to above and to execute the case logic according to the computer readable instructions comprised in the case logic.

In one embodiment of the computing apparatus, said processor arrangement is further configured to execute the case logic by entering a first state, the first state corresponding to a first process block of said case logic; executing the functionality associated with the process block corresponding to the state; generate a screen capture; causing said screen capture to be analyzed using image analysis (IR/OCR); matching the analysis of the screen capture to the associated functionality; and determining if the entered state is a terminal state, and, if so, generating a report; and, if not, following the logical flow as indicated by the case logic and entering a next state, the next state corresponding to a next process block of said case logic, and executing the functionality associated with the next process block corresponding to the state

According to one aspect of the teachings herein, in order to reduce, overcome or at least mitigate the problems listed above, there is provided a method for use in a computing apparatus, wherein said method comprises receiving a case logic as provided according to above, and executing the case logic according to the computer readable instructions comprised in the case logic.

In one embodiment said method further comprises executing the case logic by: entering a first state, the first state corresponding to a first process block of said case logic; executing the functionality associated with the process block corresponding to the state; generating a screen capture; causing said screen capture to be analyzed using image analysis (IM/OCR); matching the analysis of the screen capture to the associated functionality; and determining if the entered state is a terminal state, and, if so, generating a report; and, if not, following the logical flow as indicated by the case logic and entering a next state, the next state corresponding to a next process block of said case logic, and executing the functionality associated with the next process block corresponding to the state.

According to one aspect of the teachings herein, in order to reduce, overcome or at least mitigate the problems listed above, there is provided a computer-readable medium (2020) configured to carry instructions that when loaded into the processor of a computing apparatus capable of reading the instructions cause a functionality associated with the instructions to be executed, wherein the instructions are configured to cause the execution of the method according to above.

The use of such design tools is thus beneficial for test cases—as the inventors have realized—and also for automating tasks—as the inventors have also realized. This also provides a solution to the longstanding problem of providing test cases that can be run on any platform or at least many different platforms.

### BRIEF DESCRIPTION OF THE DRAWINGS

The invention according to herein will be disclosed in detail in the below with reference to the exemplifying figures, where:

FIG. 1A shows a schematic view of a prior art system and FIG. 1B shows a general flowchart for a method of operating a system as in FIG. 1A;

FIG. 2A shows a schematic view of a system according to one embodiment of the teachings herein and FIG. 2B shows a general flowchart for a method of operating a system as in FIG. 2A according to one embodiment of the teachings herein;

FIG. 3A shows a schematic view of a system according to one embodiment of the teachings herein and FIG. 3B shows a general flowchart for a method of operating a system as in FIG. 3A according to one embodiment of the teachings herein;

FIG. 4 shows the relationship of components of a test automation tool according to one embodiment of the teachings herein;

FIG. 5 shows a schematic view of a system adapted according to one embodiment of the teachings herein;

FIG. 6 shows one example of how a graphical interface may be used according to one embodiment of the teachings herein;

FIG. 7 shows a schematic view of an example protocol for transmitting (and/or receiving) and executing a test case or task according to one embodiment of the teachings herein;

FIG. 8 shows a schematic view of process, such as test cases or tasks and/or instances of such test cases/tasks, being executed according to one embodiment of the teachings herein;

FIG. 9 shows a schematic view of a computing apparatus according to one embodiment of the teachings herein;

FIG. 10 shows a schematic view of process, such as test cases or tasks and/or instances of such test cases/tasks, being executed according to one embodiment of the teachings herein;

FIG. 11 shows how such a building or process block 1110 is related to a screen image or screen capture according to one embodiment of the teachings herein;

FIG. 12 shows a schematic example of how an automation task is created with a flowchart and building blocks according to one embodiment of the teachings herein;

FIG. 13 shows a schematic example of how a module may be generated with a flowchart and building blocks according to one embodiment of the teachings herein;

FIG. 14 shows an example of a test case utilizing a system or arrangement according to one embodiment of the teachings herein;

FIG. 15 shows an example of a work area or canvas for a visual design tool according to one embodiment of the teachings herein;

FIG. 16 shows a method for designing a test case or task to be automated using a visual tool according to one embodiment of the teachings herein;

FIG. 17 shows a method for executing a case having been designed using a visual tool according to one embodiment of the teachings herein;

FIG. 18 shows examples of basic process or building blocks that may be used when designing a case according to one embodiment of the teachings herein;

FIG. 19 shows examples of complex process or building blocks that may be used when designing a case according to one embodiment of the teachings herein; and

FIG. 20 shows a schematic view of a computer readable medium according to one embodiment of the teachings herein.

### DETAILED DESCRIPTION

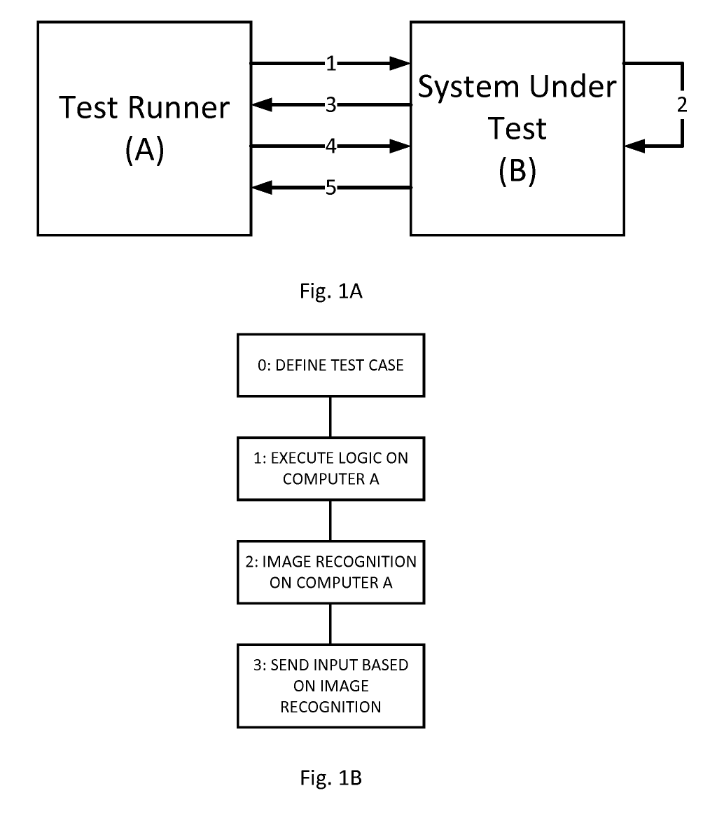

A prior art system is shown in FIG. 1A and a method for operating the prior art system is shown in FIG. 1B.

0. A test case is defined on a first computer A, using conventional approaches which typically involves programming of the case by entering text-based source code to define the different steps of the test logic of the test case.

1. The logic of the test case is executed on computer A, which uses a remote desktop connection (such as a VNC, RDP or RFB like connection) to control the user interface on a second computer B (involving a display screen and input peripherals such as a mouse and a keypad). The second computer B is the System Under Test.

2. As the test logic is executed on computer A, it runs image/text recognition on screen results obtained from computer B.

3. Based on successive results of the image/text recognition, computer A sends input to computer B, such as mouse movements and keyboard input, in order to move the test case forward.

Such a system suffers from at least from the drawback that the first computer A is allowed to take control of the second or test computer B.

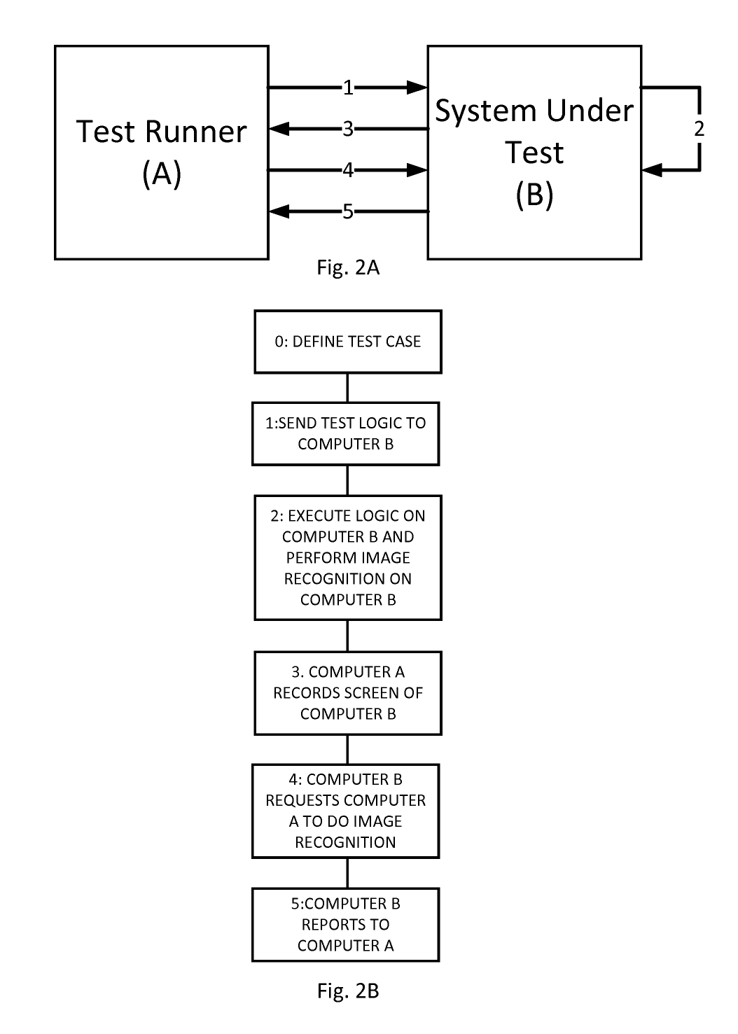

The present inventors have, after insightful and inventive considerations, developed a different system, as is seen in FIG. 2A and a method for operating the prior art system is shown in FIG. 2B. An inventive manner of designing automated tasks and tests will be also disclosed in the below. Those inventive aspects may advantageously be applied to a computer system which is disclosed in detail in different embodiments in the patent application entitled METHOD, DEVICE AND SYSTEM FOR TASK AUTOMATION OF COMPUTER OPERATIONS BASED ON REMOTE UI CONTROL AND IMAGE/TEXT RECOGNITION, which was filed on 19 Oct. 2015 in Sweden having the application number SE 1551345-0, and the contents of which are incorporated herein by reference in its entirety. One embodiment of such a system is disclosed 2A and a method for operating the prior art system is shown in FIG. 2B.

This new approach is for test but may also alternatively or additionally be used for task automation. Although the description herein will focus on test cases, it should be understood that it may also be used for task automation of tasks such as financial routines, accounting routines, searching, data aggregation and on-boarding flows. Test cases and tasks to be automated may commonly be referred to as cases herein.

0. A test case is defined on a first computer A or a separate computer and provided to computer A, possibly using conventional approaches which typically involves programming of the case by entering text-based source code to define the different steps of the test logic of the test case. As an alternative and in contrast to prior art systems, the definition of the test case and its test logic may preferably be made by way of visual flowchart script design which does not require conventional programming skills or entry of source code. Suitable visual flowchart script design technology is disclosed in the patent application entitled METHOD, DEVICE AND SYSTEM FOR TASK AUTOMATION OF COMPUTER OPERATIONS BASED ON VISUAL FLOWCHART SCRIPT DESIGN AND IMAGE/TEXT RECOGNITION, which was filed on 19 Oct. 2015 in Sweden having the application number SE 1551346-8, and the contents of which are incorporated herein by reference in its entirety.

1. Computer A sends the test logic (the flowchart) to a second computer B, where it is executed. The second computer B is the System Under Test. Computer A uses a remote desktop connection (such as a VNC, RDP or RFB like connection) to view the screen on computer B, plus preferably an extra channel for other communications. To this end, a test agent application is preferably installed on computer B instead of just a VNC/RDP/RFB application.

2. The test logic, as it executes on computer B, uses image/text recognition assisted by machine learning algorithms as appropriate to recognize objects such as shapes, patterns, colors, images and text in what is displayed on the screen of computer B, and in response decides how the test should move forward, without receiving any commands in this regard from computer A.

3. Computer A records the screen of the second computer B as the test is run. It receives continuous updates from computer B, including a status how the test is going, which is used to gather results, perform reporting, etc.

4. Image/text recognition is normally performed by computer B. In some embodiments, if there is not enough computing power available on computer B to do image/text recognition, computer B may optionally ask computer A to analyze an image of a display screen from computer B and send the result to computer B so that it (i.e. computer B) may decide how to move the test forward. Hence, again, the execution of the test logic and all relevant decisions of the successive progress of the test case are controlled by the second computer B, being the System Under Test, and not the first computer A.

5. When the test is completed, regardless of its failed/passed/done/cancelled, etc, state, computer B reports back to computer A, which can then repeat step 1 with a new test.

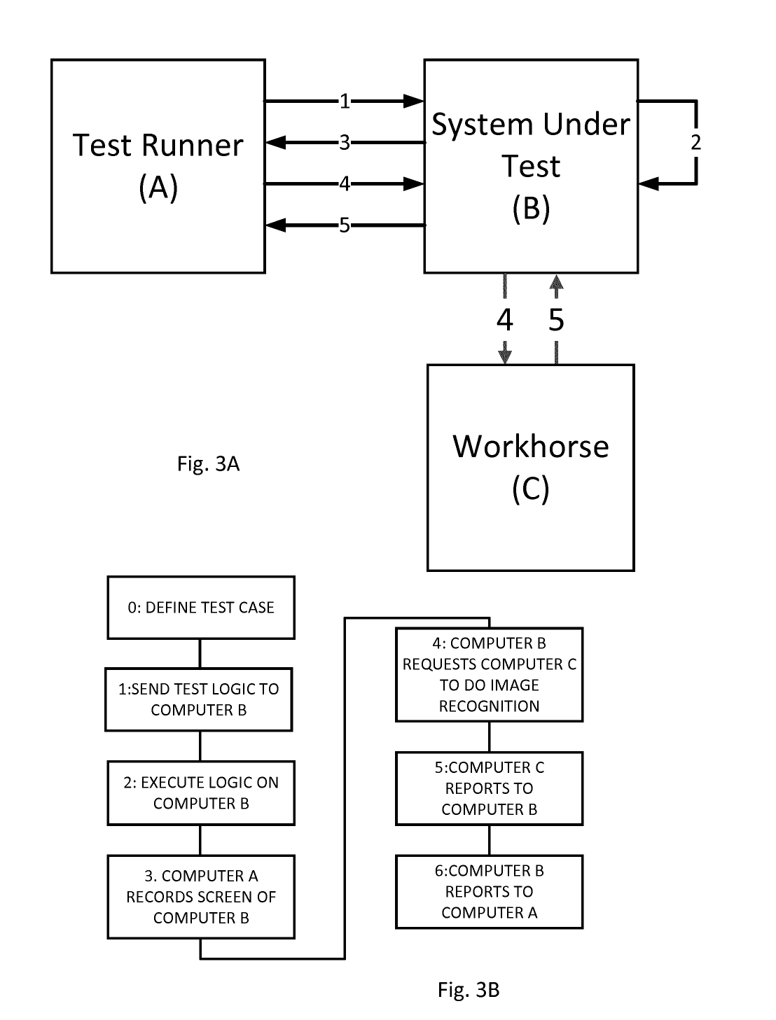

An alternative embodiment is shown in FIG. 3A and a method for operating the prior art system is shown in FIG. 3B.

The difference from the embodiment of FIG. 2 above is that instead of optionally using the first computer A for image/text recognition when there is not enough computing power available on the second computer B, the embodiment of FIG. 3 uses one or more “workhorse” computers for this (third computer(s) C).

0. A test case is defined on a first computer A as described above for the embodiment of FIG. 2.

1. The first computer A sends the test logic (the flowchart) to the second computer B, where it is executed. The second computer B is the System Under Test. The communication between computers A and B uses a remote desktop connection (a custom protocol based on for instance VNC, RDP or RFB), plus an extra channel for “extra” data.

2. The test logic, as it executes on computer B, decides how the test should move forward, without receiving any commands in this regard from computer A.

3. Computer A records the screen of the second computer B as the test is run and as it receives continuous updates from computer B, including how the test is going.

4. If there is not enough computing power available on computer B to do image/text recognition, computer B may optionally ask one or more third “workhorse” computer(s) C to analyze an image of a display screen from computer B.

5. Computer C (of which there could be multiple, working together to share the load) will send results to computer B so that it may decide how to move the test forward.

6. When the test is completed (regardless of its failed/passed/done/cancelled, etc, state), computer B reports back to computer A, which can then repeat step 1 with a new test.

This embodiment would fit larger scale environments well because the workhorse computers (C) could be scaled up or clustered, thus allowing for very fast image/text recognition of, for instance, fast-paced games.

Naturally, the computer C or one of the computers C may be at least partially executed by the computer A.

This also mitigates or solves the drawback that the test itself will affect the performance of the test computer if the test computer is to run all the image recognition while running the test, which in turn affects the test procedure as the test is no longer run under actual circumstances.

In a preferred embodiment, a test automation tool is provided which uses a custom-built visual workflow engine with building blocks to execute tests using image and text recognition, wherein no programming skills are needed to design good test cases since the tool does not at all require the need to scripting of tests—i.e. completely code free.

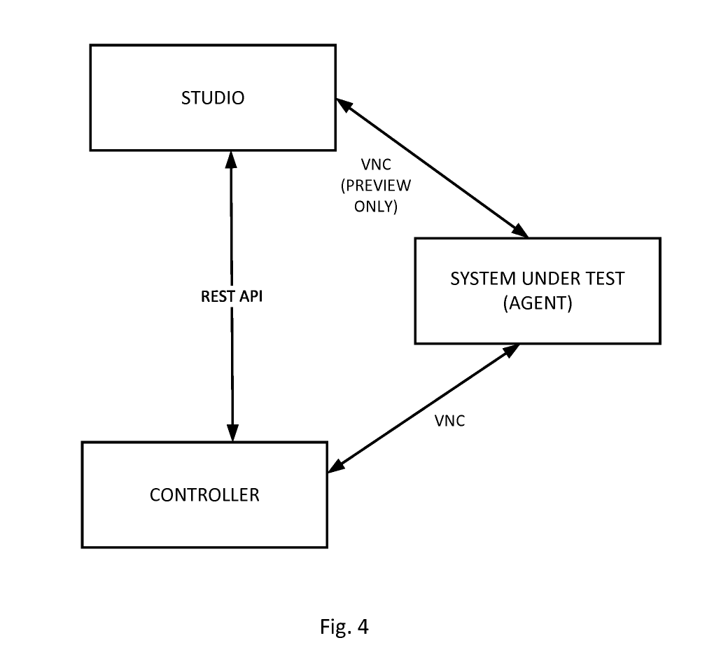

A test is designed by dragging building blocks of different kinds onto a canvas and connecting them, thus creating a logic flow with loops and conditional gates—things normally represented by a programming language. One example is shown below in FIG. 4:

The test automation tool of the preferred embodiment comprises two applications:
The Automation Studio (“Studio”) is a visual application that the users see. It is used to create test cases (visual workflows), see result reports and more.
The Automation Controller (“Controller”) is a service application that is used to schedule and run tests. It is either installed on the tester's machine or on a central server, allowing teams to collaborate.

The test automation tool of the preferred embodiment also comprises a third application, namely the Agent application (“Agent”) or System Under Test (SUT) which will be described in detail below.

Studio and Controller communicate with each other using an HTTP-based REST API that the Controller provides. Studio can be thought of as the “front-end” for the test automation tool, while the Controller is the “back-end”—it is where all assets (tests, images, building blocks, etc) are stored.

The Controller connects to another computer or device where the tests should run, known as the “System Under Test” or “SUT” as referred to above, through a remote screen connection. Such a remote screen connection means that computer A is able to view what is on the screen on computer or device B. Different protocols exist for this, such as for instance the VNC protocol as referred to above.

FIG. 4 illustrates the relationship between Studio, Controller and a SUT. The Controller dispatches the visual workflow (the building blocks and their connections in the example above that was designed in Studio) to the Agent which executes the test by iterating through the components of the workflow while being connected to a SUT. It uses the screen input to do image and text recognition and performs the test logic accordingly.

FIG. 5 shows a schematic view of a system 100 adapted according to one embodiment of the teachings herein. The system 100 may be seen as a combination of the systems shown in FIG. 3A and FIG. 4. The system 100 comprises one or more studio arrangements 110. A studio arrangement 110 may be a computer adapted to run a studio software module, which software module is designed to enable a test or task developer to visually design a test case or task using a graphical interface, simply dragging and dropping boxes and building a case logic without needing programming skills or knowledge of the platform to execute the case. More details on such a visual case logic generator has been disclosed in the above-referenced SE 1551346-8, to which reference is given for more details on how to design a test case or a task automation.

In the following focus will be on designing and executing a test case, but as should be understood and as has been explained above, the same mechanisms and functions may be used when designing and execution an automated task, both referred to as a case.

The present inventors have, after insightful and inventive considerations, developed a different approach. In contrast to prior art systems, the definition of the test case and its test logic is made by way of visual flowchart script design which does not require conventional programming skills or entry of source code. Hence, if applied to the exemplifying prior art system in FIG. 1 above, step 0 would be substantially modified so that the different steps of the test logic of the test case are not defined by programming of the case by entering text-based source code, but by visual flowchart script design.

To illustrate this difference, an example is given below of a functional/-regression test case written in the conventional “by hand” in the popular open source project Selenium. It is a very simple web test that:
Opens a Chrome web browser,
Navigates to the website www.topholt.com,
Searches for the text “Topholt Solutions”,
If the text is not found, it retries 3 times before failing.

The source code (in the programming language C#) of the test case when defined in the conventional manner is shown in Table 1 below:

TABLE 1
Example code for a test case.

```
using System;
using Microsoft.VisualStudio.TestTools.UnitTesting;
using OpenQA.Selenium;
using OpenQA.Selenium.Chrome;
namespace MySeleniumTestProject
{
    [TestClass]
    public class UnitTest1
    {
        [TestMethod]
        public void TestMethod1( )
        {
            int count = 0;
            // Open a Chrome instance.
            IWebDriver driver = new ChromeDriver( );
            // Repeat a maximum of 3 times.
            bool found = false;
            while (count < 3)
            {
                // Go to the website address.
                driver.Navigate( ).GoToUrl
                (“http://www.topholt.com”);
                // Look for the company name.
                found = driver.PageSource.Contains
                (“Topholt Solutions”);
                If (found) break;
                count++;
            }
            driver.Close( );
```

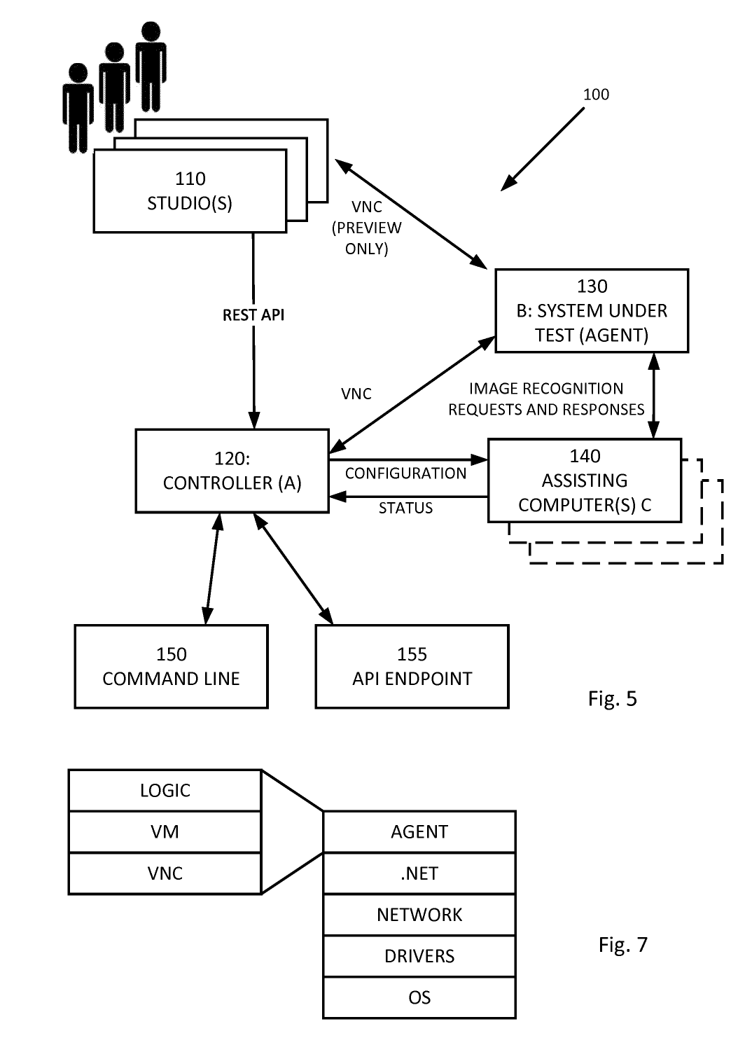

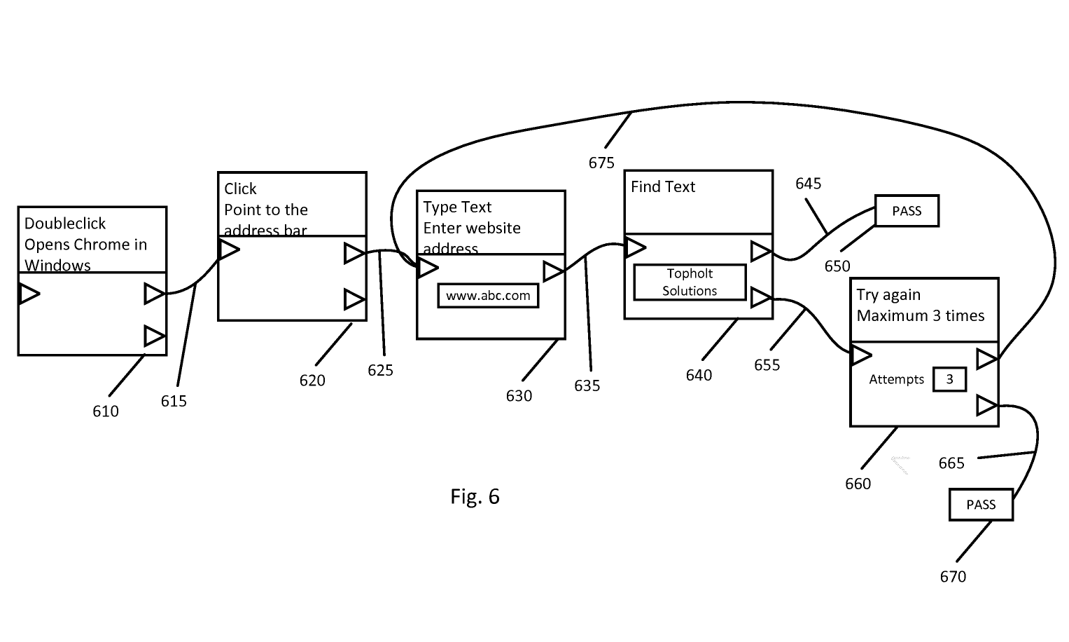

The same test case, produced according to the present inventive aspect, is shown in FIG. 6 which shows one example of how a graphical interface is used according to the teachings herein to design a test case or task to be automated. Building blocks 610-660 are dragged onto a canvas, each building block representing a case process step. The building blocks 610-660 are connected by flows 615-690 representing the transient taken to reach the next building block. By cleverly selecting a base offer of building blocks, a state machine for the test may thus be constructed even without the operator knowing what a state machine actually is. The user simply selects a building block representing the next action to be taken and connects it to the previous step/action.

Each building block has an upper informative area, where the function of the block is explained, and a lower functional area, where the functionality of the block is specified.

In the example of FIG. 6 an example of how to test that a certain webpage belongs to an address is provided. In an initial block 610 the SUT is instructed to double click on an icon for a web browser. The functionality associated with the first block 610 is to double click on a specific icon, which implies that the process of capturing the screen, performing image recognition on the screen capture to find the location of the specified icon (being the associated data), and performing a double click action on that location, i.e. providing the platform to be tested with the input of a double click event giving the found coordinates. As the first block is executed, the system under test proceeds with following a logical flow path associated with the block. The first block 610 is connected to a second block 620 via a first logical flow path 615. The second block 620 is associated with the function of moving the cursor to the address bar. The second block 620 is connected to a third block 630 via a second logical flow path 625. The third block 630 is associated with the function of typing text at a current position and the associated data specifies which text to type, the block thus causes the system under test to provide the text as input (and at the current location) to the system. As the cursor has been put in the address bar by the second block 620, the text is inputted in the address bar specifying which address to load. The third block 630 is connected to a fourth block 640 via a third logical flow path 635. As the text has been input the logical flow of the case thus takes the system under test to the next block, which in this example is a block associated with a function of finding a text (the text being an associated graphical or user interface object), namely to capture the screen and perform optical character recognition (or other image recognition) on the screen capture to find the associated text. The fourth block 640 is connected to both a fifth block 650 via a fourth logical flow path 645 and to a sixth block 660 via a fifth logical flow path 655. As the associated find text function may not be able to find the text it may obtain two states after the OCR has been performed, namely PASS indicating that the text was found (and possibly the location of the found text) and FAIL indicating that the text was not found.

In this example the fourth block 640 is connected to the fifth block 650 being a final block indicating a pass of the test case through the fourth logical flow path 645 which will be followed if the find text function passes. The associated function of such a final pass block 650 is to signal to the system under test that the case passed, which can be signaled to the controller 120. The fourth block 640 is also connected to a sixth block 660 through the fifth logical flow path 655 which will be followed if the find text function fails. The sixth block 660 is associated with a repeat function which carries an associated data of the number times to repeat something. This block is thus associated with a counter that is increased every time the block is visited. If the counter exceeds the specified number, one logical flow path is followed, in this instance a sixth logical flow path 665 to a seventh block 670, being a final block associated with a FAIL, namely a function that a fail of the test case is reported and the test case ends. If the counter does not exceed the specified number, another logical flow path is followed, in this instance a seventh logical flow path 675 leading back to the third block 630 of inputting the address of the web page to be found. This use of the sixth building block or process block 660 thus provide for a functionality of repeating one or more steps in the test case until a desired result is found (or not).

At least one building block or process block is thus associated with the function of capturing a screen and analyzing the screen capture to identify a matching graphical or UI object, such as text that is analyzed through for example optical character recognition or an image that is analyzed through for example image recognition. The results of the image analysis are thus matched against the associated functionalities.

The inventors have realized that such a design manner may advantageously be used for designing a test case or other task to be automated, as these cases will often follow a specific logical flow regardless of what platform it is to be executed upon. This manner thus provides for test designer to focus on the logical flow of the test instead of implementation details such as text formats, positions, coordinates, and so on which may differ significantly from one platform to another.

In this application focus will be on designing and executing a test case, but as should be understood and as has been explained above, the same mechanisms and functions may be used when designing and execution an automated task, both referred to as a case.

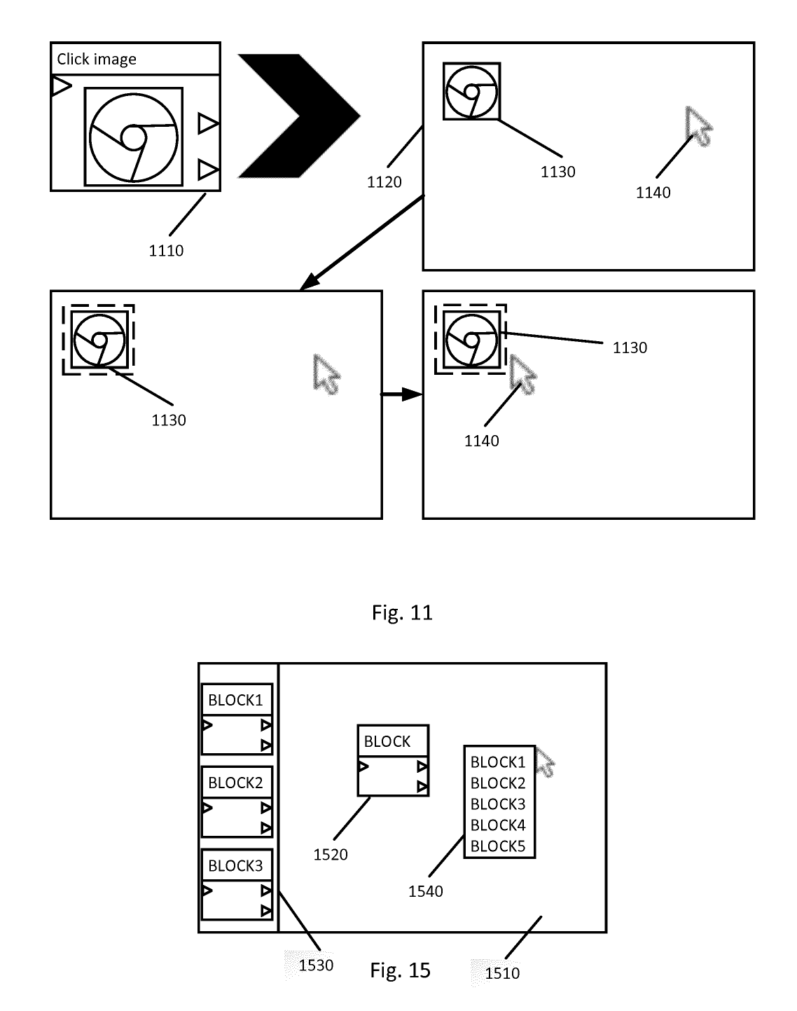

Hence, a method has been invented for creating and executing software process automation tasks (e.g. test cases) by designing flowcharts with building blocks and performing image/text recognition of objects expected to appear on the display screen of the System Under Test when the automation task is executed. This can be used to automate many different tasks, such as repetitive IT operations (starting and stopping software services, executing scripts, monitoring output from applications, etc.) as well as automation of user interface (UI) tests. For further details on this manner of designing cases, we refer to the description of FIGS. 11 to 19 below.

Returning to FIG. 5, the system 100 also comprises a controller or controlling computer referred to as A or controller in the above disclosed systems with reference to FIGS. 2A, 3A and 4.

The controller may be accessed through a command line 150 and/or through an API (Application Programming Interface) endpoint 155.

The studio(s) 110 may be arranged to design the case logic locally, or already at the controller 110 through an interface possibly using the visual interface discussed in the above. As a case has been designed, the corresponding logic is sent to the controller (possibly to be compiled by the controller).

A studio 110 may be implemented as a virtual machine to be executed on the same computer as the controller 120. Likewise the controller 120 may be implemented as a virtual machine to be executed on the same computer as a studio 110. In the following there will be made no distinction between these cases and the entities will simply be treated as logically separated entities even if executed on the same computer or other device. Each studio is operated by one or more operators. Or, a same operator may operate more than one studio.

The system 100 also comprises a system to be tested 130 or SUT, also referred to as computer B. As the controller 120 has compiled the test logic into a format that is readable by the system to be tested 130, the controller transmits the test logic to the system to be tested 130. In transforming the test logic to a readable format, the controller may be configured to de-serialize the test logic into an object format. Or the de-serialization may later be performed by the system under test 130.

As the system to be tested receives the test logic it loads it as objectified code in a virtual machine to be executed on the system to be tested 130.

The controller 120 thus only receives the test design and ensures that it is transmitted or dispatched to the system to be tested in a format that is readable by the system to be tested 130. It does not give any other commands or interferes in the execution of the test or task. As such, it can not control the functionality of the system to be tested 130—apart from supplying the test logic, and possibly cancelling, aborting or pausing the test case or other general control of the actual test case (start, abort, restart and so on).

The system under test or SUT 130 thus executes the test case—possibly after further compiling for adapting the logic to the system of SUT 130. The test logic, when designed in the studio 110 and handled by the controller 120, is thus independent of the architecture that it is to be run on which simplifies its design greatly as the test designer need not be aware of the final architecture to be tested, but can focus on the test case and its logical flow.

This system arrangement allows for an agent having a system to be tested to connect to a controller—or ensure that the SUT 130 is connected to the controller 120—and request a test as having been designed by a studio 110.

The controller thus only provides the case logic to the SUT without sending any intermediate commands relating to the case logic (possibly apart from a cancel, abort or pause command). In one embodiment, the case logic is transmitted in a single step (possibly divided into several data packets)

FIG. 7 shows a schematic view of an example protocol for transmitting (and/or receiving) and executing a test case or task according to the teachings herein. On a lowest level there is an operating system layer OS, which in turn may comprise several layers, such as a physical, connection and other protocol layers. The OS layer communicates with higher level functions through a network layer (NETWORK) utilizing various drivers (DRIVERS). An agent layer AGENT is arranged to communicate through the network layer NETWORK for executing a test case or task. The agent layer is based on a software development platform, such as, for instance, Microsoft .NET. The agent layer in turn comprises at least three layers, a lower RFB—Remote Frame Buffer—(such as VNC or the like) layer for receiving the logic, a virtual machine VM layer for providing the execution platform and a logic layer LOGIC comprising the logic necessary to execute the test logic. As a skilled person would understand, other computing environments would possibly utilize a different protocol.

As the agent or SUT 130 has received a test logic and possibly compiled it to a suitable format for execution, the agent basically performs the following simple test or task service. First a reference screen capture is generated, and then the agent loops the following. Input is received from the virtual machine and a new screen capture is generated and compared to the reference. If there is any change to the screen capture then an action (according to the logic) is performed and a new screen capture is generated being compared to the previous one, now acting as the reference screen capture.

During execution the test logic relies on comparisons of screen shots or screen captures using image recognition (IR) and/or optical character recognition (OCR) software. By checking results using IR and/or OCR, the partial test results can be evaluated regardless of the platform on which they are being executed on. Also, decisions on how to proceed are made based on the partial results based on images/text only. The actual image and/or text being displayed will not differ greatly between different platforms, only the placement and/or size (or format) will differ. Thus, by focusing on the visual content and/or the textual content, partial results can easily be identified regardless of the platform.

As the test or task has been executed, the SUT reports back to the controller 120 whether the test passed or failed, possibly with information relevant to the test, such as any value of a sought for variable.

The studio(s) may also be enabled to view the test as it is being executed on the SUT 130 through a remote interface, such as a VNC interface, but only allowed to view the screen of the SUT—not to control it.

To enable the SUT 130 to focus (solely) on the actual test case or task—and to not compromise the integrity of the test case by taxing the SUT 130 with tasks it would normally not perform, the SUT 130 or agent may be configured to optionally connect to an assisting device or computer, also referred to as computer C, for performing the image recognition and/or text recognition, at least a portion of it. As especially image recognition can require vast computer resources, they may influence the test environment significantly.

The inventors of this application has realized this and therefore devised a system 100 wherein the image recognition, text recognition and/or other computationally heavy tasks are delegated to assisting computer(s) C.

In one embodiment the assisting computer C may be implemented on the same computing apparatus as the controller A, the controller and the assisting computer thus being the same physical entity, and possibly also the same logical device.

The assisting computer C or a plurality of assisting computers C may thus be utilized to offload the SUT 130. This is beneficially used to enable the SUT 130 to perform under as normal conditions as possible for a more reliable test of the SUT's actual operation. It also enables the timing of various aspects in the test to be maintained.

The controller 120 is, as has been mentioned, not enabled to control the SUT or otherwise interfere in the test. However, it may be configured to configure the assisting computer(s) 140, possibly for setting an image quality or size to be used or a reporting format to be used. Likewise, even though the SUT itself controls the progress of the test and only reports fail/pass to the controller, the assisting computer(s) 140 may be configured to provide status reports to the controller 120.

The test or task logic being designed at the studio 110 may be given in a scripted object language such as through JSON objects. This script code, which is serialized as it is stored and transmitted, is de-serialized by either the controller 120 before transmitting the test logic, or by the SUT 130 as it receives the test logic into objects or being objectified to be executed by the SUT 130.

The SUT and/or the controller may be arranged to execute tests or even objects or instances within a test case or task in serial. This allows for a series of tasks or tests to be performed without further (user) intervention.

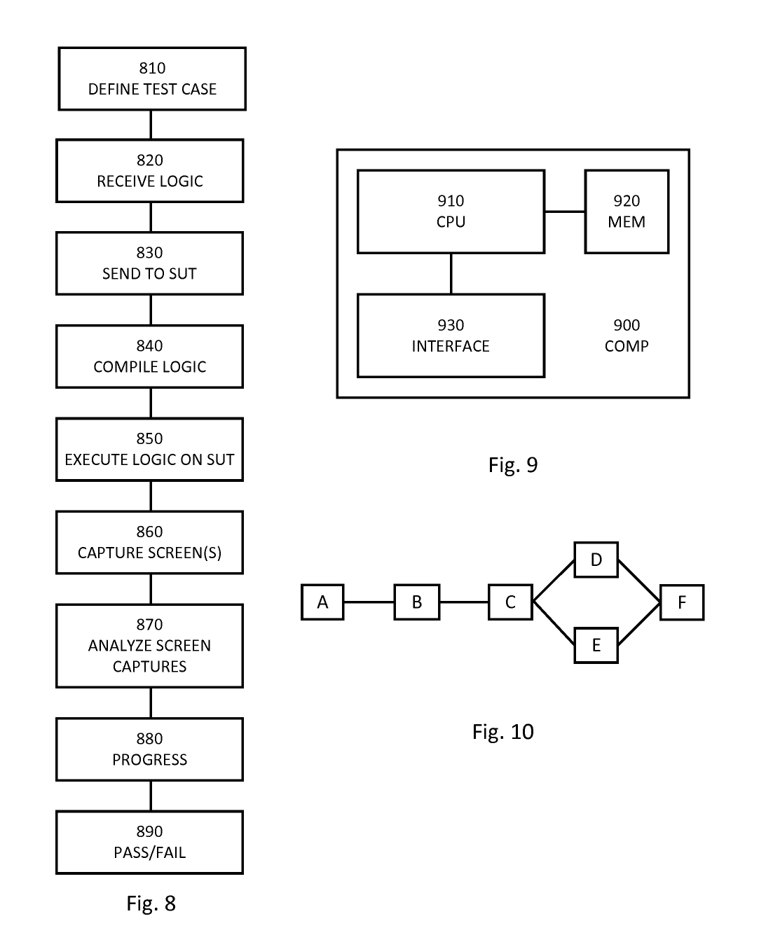

The SUT and/or the controller may alternatively or additionally be arranged to execute tests or even objects or instances within a test case or task in parallel. This allows for a number of tasks or tests to be performed in parallel without further (user) intervention. This enables for computing resources to be better utilized during the awaiting of a process, and also allows for more advanced timing aspects. FIG. 8 shows a schematic view of process, such as test cases or tasks and/or instances of such test cases/tasks, being executed both in series and in parallel. As can be seen, tasks A, B and C are all executed in series, whereas tasks D and E are executed in parallel, but in series with tasks A, B, C and F.

The flow of a test case or task automation according to the teachings herein may be shown as in FIG. 8. A test case is defined 810 by the studio 110 and sent to the controller 120. The controller 120 receives 820 the logic and possibly stores it for future reference, such as when repeating a test or task. The test or task logic is then transmitted 830 to a system to be tested 130 and is compiled 840 into a format that can be executed by the SUT, before, during or after transmission. The SUT then executes 850 the test or task logic and of course any functions as instructed by the test logic. During the execution various screen images are generated and captured 860. The screen captures are analyzed 870 through image recognition or optical character recognition to identify elements corresponding to instances of the test logic. For example, the test may be designed to open a webpage and look for a result, wherein both the icon to be clicked and the result looked for are identified and localized in the screen capture. The SUT simply looks for an icon resembling the webpage icon as indicated in the test logic (possibly this is outsourced to an assisting computer) and then acts on the position found for the icon. More options for what items are matched will be given when disclosing how a test case is designed below.

The test or task is thus both visually designed and also operated or run. By designing the test or task to be visually oriented the test or task becomes independent on the actual platform used to execute the test or task. It also becomes independent of any positioning made by an operator of the SUT.

As partial results are achieved, the test or task progresses 880 until a pass or fail is determined, that is until it is determined that the test case or the task was executed successfully (pass) or unsuccessfully (fail) 890, such as by giving the incorrect data or no data at all, at which time the test or task is finished or completed.

By enabling the SUT to execute and handle the test logic, both the studio and the controller are thus made independent on the platform to be tested. Only an agent will be dependent on the platform to be tested, which is natural as the agent is the platform.

In this manner a test or task may be designed for multiple platforms at once, without the designer having any knowledge of specific platform issues. This greatly saves on the design time and also design complexity. An operator may simply focus on the logical or functional flow of the task to be executed or tested.

The role of the controller 120 is thus simply to provide and start/cancel a test that is run on an agent. The agent 130 executes all logic, but may utilize an assisting computer for outsourcing tasks such as image recognition, wherein the controller 120 may act as an assisting computer.

FIG. 9 shows a schematic view of a computing apparatus 900. The computing apparatus may be utilized to implement a studio 110, a controller 120 and/or a system under test 130, as well as an assisting computer 140. The computing apparatus may also or alternatively be used to implement one or more of the studio 110, the controller 120, the system under test 130, and/or the assisting computer 140 as a virtual machine being executed on the same computing apparatus 900.

The computing apparatus comprises a processor arrangement 910 CPU, comprising one or several central processing units, programmable logic circuits or other processors. For the sake of this application the various possibilities in setting up a processor arrangement will not be discussed in greater detail, and as a skilled person would understand, the various arrangements of which actual processor performs which action will be regarded as the action having been executed by the processor arrangement.

The processor arrangement is connected to a memory 920 MEM for storing instructions and data for the instructions to operate on. The memory 920 may be local and/or external. The memory 920 may also comprise several hierarchical levels. As for the processor arrangement 910, this application will not delve into the finer aspects of memory architecture, but all memories will be regarded as the same memory 920.

The processor arrangement is connected to an interface 930. The interface may comprise a user interface for presenting data on a screen and for receiving instructions from an operator, such as the graphical test logic design tool executed on the studio 110, a user interface for receiving test commands (initiate/cancel) for the controller 120, and a user interface for receiving or simulating user interactions on the system under test. Examples of such user interfaces are various keyboards and pointer devices. The interface 930 may alternatively or additionally comprise a communication interface for receiving and/or transmitting data, such as a communication interface for transmitting the test logic from the studio 110 to the controller, or from the controller 120 to the system to be tested 130, a communication interface for transmitting screen captures to assisting computers 140 and/or for transmitting results of screen capture analysis to the system under test 130 from the assisting computer to the system under test, communication interface for transmitting configuration commands from the controller 120 to the assisting computer 140 and/or for transmitting status data from the assisting computer to the controller 120.

The interface 930 may be wired and/or wireless. Examples of wired interfaces are computer bus-based interfaces in case of virtual machines or user interfaces and/or network interfaces in case of device-to-device communication. Examples of wireless interfaces are cellular (Global System Mobile, 3G, Long Term Evolution), close range radio frequency interfaces (Bluetooth®, WiFi (IEEE standard 802.11s) or ZigBee®).

In one embodiment the interface 930 comprises a remote desktop interface also referred to as a virtual network computing (VNC) which enables one computing apparatus to control another computing apparatus.

As used herein, a computer may relate to a physical computer, a virtual machine or a cloud-based computing resource.

The SUT and/or the controller may alternatively or additionally be arranged to execute tests or even objects or instances within a test case or task in parallel. This allows for a number of tasks or tests to be performed in parallel without further (user) intervention. This enables for computing resources to be better utilized during the awaiting of a process, and also allows for more advanced timing aspects. FIG. 10 shows a schematic view of process, such as test cases or tasks and/or instances of such test cases/tasks, being executed both in series and in parallel. As can be seen, tasks A, B and C are all executed in series, whereas tasks D and E are executed in parallel, but in series with tasks A, B, C and F.

Returning to the example of FIG. 6, the first process block 610 was an example of a block having a picture associated with it. Another example of such a block is a click image block 1110, see FIG. 11, which is associated with the functionality of both finding an image and providing the input of a click event at the coordinates of the found image.

FIG. 11 shows how such a building or process block 1110 is related to a screen image or screen capture. In this example there will be no difference made between the screen and the screen capture for illustrative purposes. The functionality causes a screen capture of the currently displayed screen 1120 to be taken and analyzed through image recognition. The image recognition serves to identify the associated data, namely the icon 1110. As a matching icon 1130 is found in the screen capture, as is indicated in the bottom-left version of the screen in FIG. 11 by the dashed rectangle, thereby finding the coordinates of the matching icon, upon which click event is generated for these coordinates and sent to the system under tests input unit. The cursor 1140 is thus moved to the location of the matching icon as is indicated in the bottom right version of the screen.

In one embodiment, multiple matching icons may be handled, and such multiple found matching icons may be handled in the order as specified by the test designer.

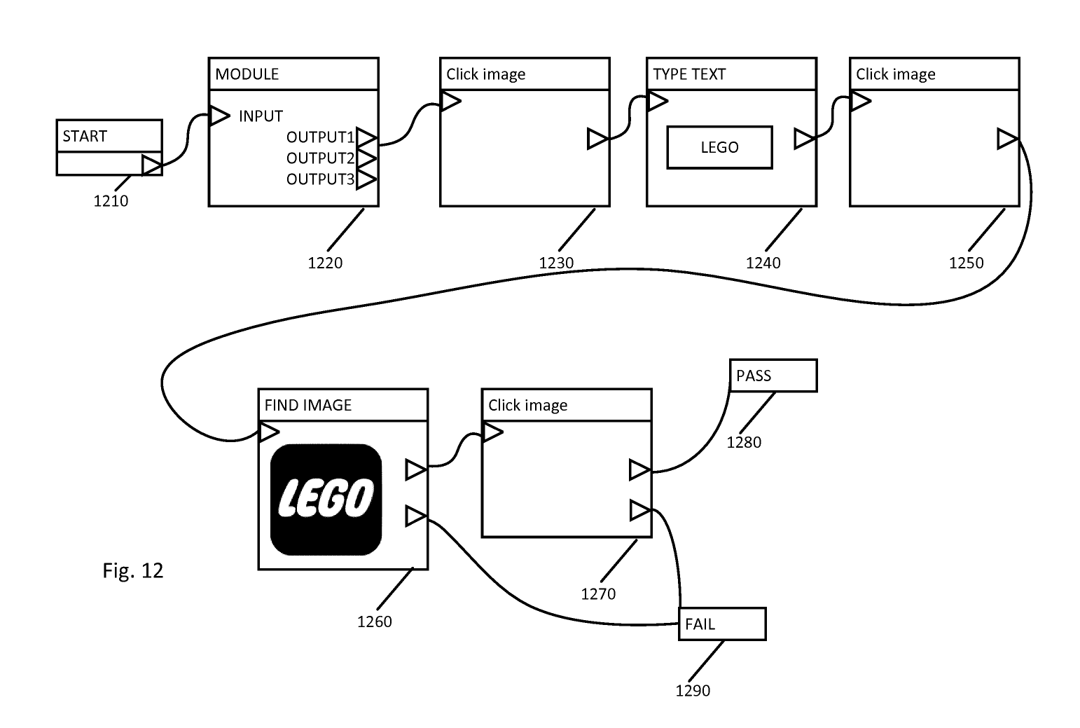

One manner of designing a test or other case by using a visual tool is explained above with reference to FIG. 6, however, the inventors have realized that this manner may be expanded to make it more versatile, while being just as easy to work with when designing cases. FIG. 12 is a schematic example of how an automation task (in this case, a UI test) is created with a flowchart and building blocks.

In this example (and the other examples), a logical port representing a fail of that block is indicated by a crossed triangle/arrow, whereas a normal or pass logical port is represented by an empty triangle/arrow. The logical ports are where the logical flow paths connect.

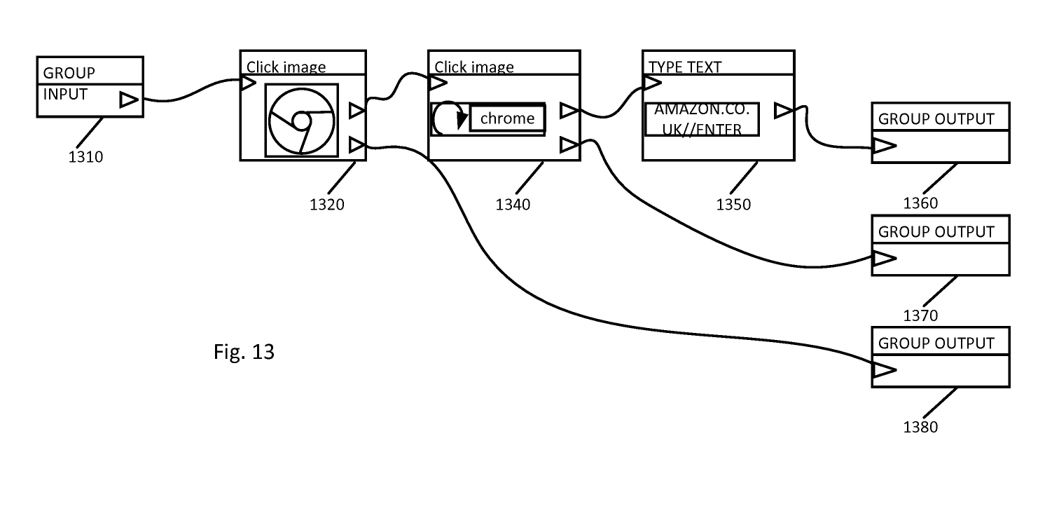

As can be seen the example of FIG. 12 comprises a module block. Such modules are useful for grouping building blocks and re-use them in other automation tasks. The “MODULE” building block 1220 of FIG. 12 is such a re-usable building block, and it contains the following inside, as is seen in FIG. 13.

The flowchart and building blocks above together with image and text recognition perform the following on a target system:
The test is started.
Click on the “Chrome” icon to open the browser.
Click on the address bar in the browser.
Type “amazon.co.uk” and then ENTER.
Click the search text box on Amazon.co.uk when it appears.
Type the text “Lego”.
Click the “lego in Toys & Games” item in a dropdown-menu that will appear.
Find a specific LEGO set.
Click the “X” button to close the browser.
The test is now passed.
If the LEGO set or the “X” button is not found, the test is failed.

When the task is run, image and text recognition is used on a target computer to find and interact with areas on the screen. In the example above, for instance the easily recognizable “Chrome” icon is clicked.

There is a long list of different building blocks that perform different jobs; for instance, the “Click Image” building block is used to click an image. The “Type text” building block is used to type text. A “Math” building block (not shown here) does integer math on two input values. A “Database” building block reads data from a database and allows it to be used in other building blocks.

The user creates the automation task (in this case, UI test) by dragging or otherwise adding building blocks to a flowchart canvas, then clicking on each one to configure various properties, including capturing text and images on a remote target system. Building blocks have input and output “connectors” that allow values and signals to be passed on from one block to others.

In the example above, the “Click Image” building block with the “Chrome” icon will pass the position of the found icon on to the next building block, or a “False” signal in case of “Not Found”. There are many different types of values the building blocks can pass to each other, including text, numbers, dates, images, positions, areas, tables, lists and more.

Returning to FIGS. 4 and 5, and as has been described above, a test automation tool may be provided in a preferred embodiment which uses a custom-built visual workflow engine with building blocks to execute tests using image and text recognition, wherein no programming skills are needed to design good test cases since the tool does not at all require the need to scripting of tests—i.e. completely code free.

A test is designed by dragging building blocks of different kinds onto a canvas and connecting them, thus creating a logic flow with loops and conditional gates—things normally represented by a programming language.

The test automation tool of the preferred embodiment consists of two applications:
The Automation Studio (“Studio”) is a visual application that the users see. It is used to create test cases (visual workflows), see result reports and more.
The Automation Controller (“Controller”) is a service application that is used to schedule and run tests. It is either installed on the tester's machine or on a central server, allowing teams to collaborate.

The Studio and Controller communicate with each other using an HTTP-based REST API that the Controller provides. Studio can be thought of as the “front-end” for the test automation tool, while the Controller is the “back-end”—it is where all assets (tests, images, building blocks, etc) are stored.

The Controller connects to another computer or device where the tests should run, known as the “System Under Test” or “SUT” as referred to above, through a remote screen connection. Such a remote screen connection means that computer A is able to view what is on the screen on computer or device B. Different protocols exist for this, such as for instance the VNC protocol as referred to above.

The inventors have thus realized that such a visual tool for generating a case logic based on the logical or functional flow of the case may be used for designing test cases, and especially when paired with image recognition and/or text recognition.

The inventors also provide for an expansion of the concept of having logical flows, which expansion the inventors have realized can beneficially be used for designing test cases and other task automation.

The expansion relies in addition to provide logical flow paths (or process paths) also provide data flow paths. The process or logical flow flows in one direction, progressing the case logic a state (or more) at a time. The data flow indicates how data is transferred (or flows) between different states.

In one aspect of the invention disclosed herein the data flow is set in an order opposite that of the progress of the logical flow. That is, instead of specifying to whom data is to be sent to, one specifies from where the data is to be collected. This allows for an easier design phase as the designer need not bother about the data until it is needed by a block. The designer thus does not need to know all possible blocks and what blocks will be needed in the future when designing the case logic. Furthermore, it saves on execution time as data is only determined explicitly and transferred as it is needed, that is when a state is reached that actively asks for the data. The data flow can thus be seen to flow in the reverse direction as to the process flow, at least it is handled in the opposite direction.

A processor arrangement, such as the processor 910 of a computing apparatus 900 being comprised in a system under test 130, is thus configured to determine a next block to go to as it reaches or processes a block and to determine from which previous block data may be fetched.

By arranging the data calls to be made retroactively, the designer need not specify exactly what data should be transferred, in what form or to what future block. Data is only handled once it is needed, and then retroactively.

This may of course also be specified during compilation so that the data is part of a new functional call, but as this is done by the compiler for the specific platform, the designer need not be aware of this during the design phase. The compiler receiving the complete case logic of course also knows which data will be needed and may deal with data flows in whichever order it wishes to.

However, for generalized block handling and to reduce the amount of data to be sent it is simpler to only retrieve the data actually needed (when need) than to enable all data to be propagated through the system (regardless of whether they will be used or not) or enable variable functional calls, which are difficult to design and maintain for various updates and upgrades.

The system(s) proposed herein is thus beneficial to use for a designer and also easy to implement for a programmer.

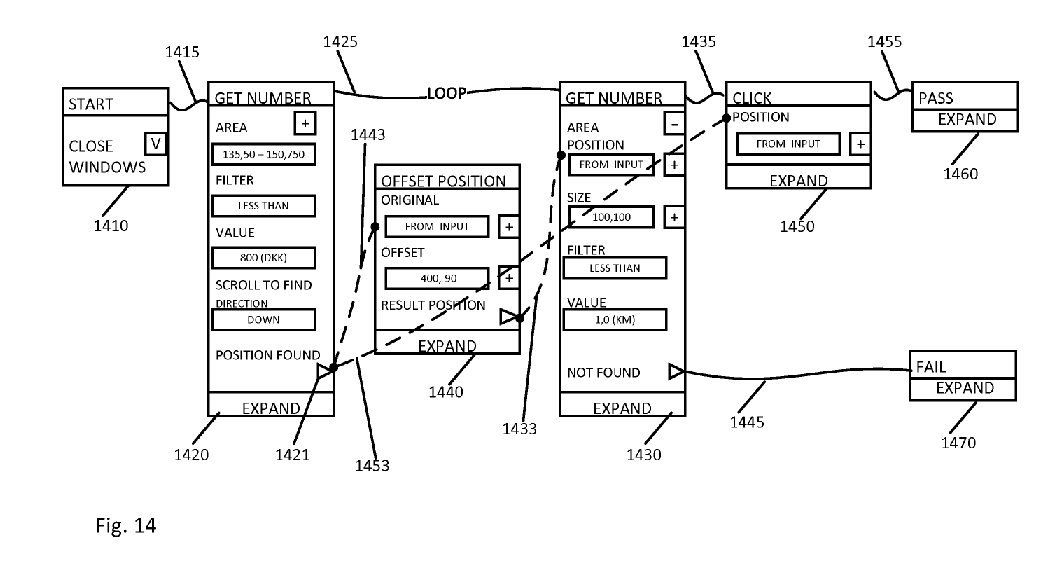

An example of a test case utilizing such a system or arrangement is shown in FIG. 14. An initial start block 1410 has been chosen, possibly by being dragged from a tool bar onto a canvas, or by clicking on the empty canvas to produce a menu of options to choose from of blocks to place at the clicked position, see FIG. 15.

FIG. 15 shows an example of a work area or canvas 1510 for the visual design tool. A process block 1520 is placed on the canvas 1510 by being dragged from a toolbar 1530, comprising a number of blocks to be selected, or selected from a popup-menu 1540.

The initial start block 1410 has a choice which when selected causes all windows to be closed as the start block is reached during execution of the test. Thus, checking this option causes all open windows to be closed s this test is executed. This enables for the test to be run in a clear and uncluttered area where images, such as icons, may be found more easily. The initial start block 1410 is connected through a logical flow path 1415 to a second functional block 1420 being a get number block. The get number block 1420 shows a number of options that may be specified by the designer for indicating what number is to be found and where. As can be seen by the plus-boxes, an option may be expanded or not to show more or hide options. In this example the area to be searched is given by start coordinates and indications of size in respective axes. The block also has a data output port 1421 for providing the position of the found text. The second block 1420 enables for finding the value 800 (DKK) in a specified area, thus allowing a tester to automatically find the value without knowing exactly where it will be displayed.

The second block 1420 is connected to a third functional block 1430 by a second logical flow path 1425, the second block also being a get number block. In this block the area in which to search for the number has been expanded to further specify the area/location. As the position is chosen to be from input (“FROM INPUT”), the functional block causes the processor arrangement executing the block to find the data on the input port of the block (indicated by the black dot ending the dashed line). The processor arrangement is configured to determine which block the input (for this parameter) is connected to via a first data flow path 1433, which block in this case is a fourth functional block 1440, being a functional block for offsetting a position. This fourth block is in turn connected to the second functional block 1420 via a second data flow path 1443, the fourth block thus being called firstly when the position is needed, whereby the fourth block retrieves the found position from the second block 1420, offsets it (by −400,−90) and provides it as input to the third block. Note that there is no logical flow path connecting the fourth functional block, this is unnecessary as the fourth block is, as such, not part of the logical flow of the test case; it is only for transforming an entity.

The third block in combination with the fourth block enables for finding a number at a position offset the position at which the first value was found (800 DKK). This enables for finding data that one knows the relative position for.

From a design perspective, the designer need not know exactly where and when the position found is to be used and can leave it hanging when designing the test case logic. Neither does the designer need to worry firstly about data parameters and its use, but can focus on the logical flow, which in this case is: first find the value 800, then find values less than 1.0 km. This allows for finding for example hotels at a set price range (less than 800 DKK) and of these find the hotels that are less than 1.0 km from the beach.

The third block is in turn connected via a third logical flow path 1435 to a fifth functional block 1450 which is a click position block. This block 1450 carries the parameter of a position to be clicked, which position is specified to be taken from the input port of the block, the input port in turn being connected to the second functional block 1420 via a third data flow path 1453. As a hotel has been found, the hotel is selected by clicking on the price (usually being selectable). The fifth block 1450 is connected to a sixth functional block 1460 being a terminal block indicating a pass.

The third block 1430 is also connected to a seventh block 1470 via a fourth logical flow path 1445 which is only reached if the number searched for is not found. A block may thus be arranged to have more than one logical successor depending on the outcome of the associated functionality.

Functional blocks may also be arranged to be expanded to show more or fewer alternatives, this saves space on the canvas when designing test cases.

As is indicated a logical flow path may be repeated. This is indicated in FIG. 14 by the second logical flow path being set to be looped while the corresponding functional block provides a positive (pass) result. The corresponding block will be the next block as the logical flow always flows in the same direction. In this example, this enables for finding all hotels that are within 1.0 km (from the beach for example) and has a price less than 800 DKK.

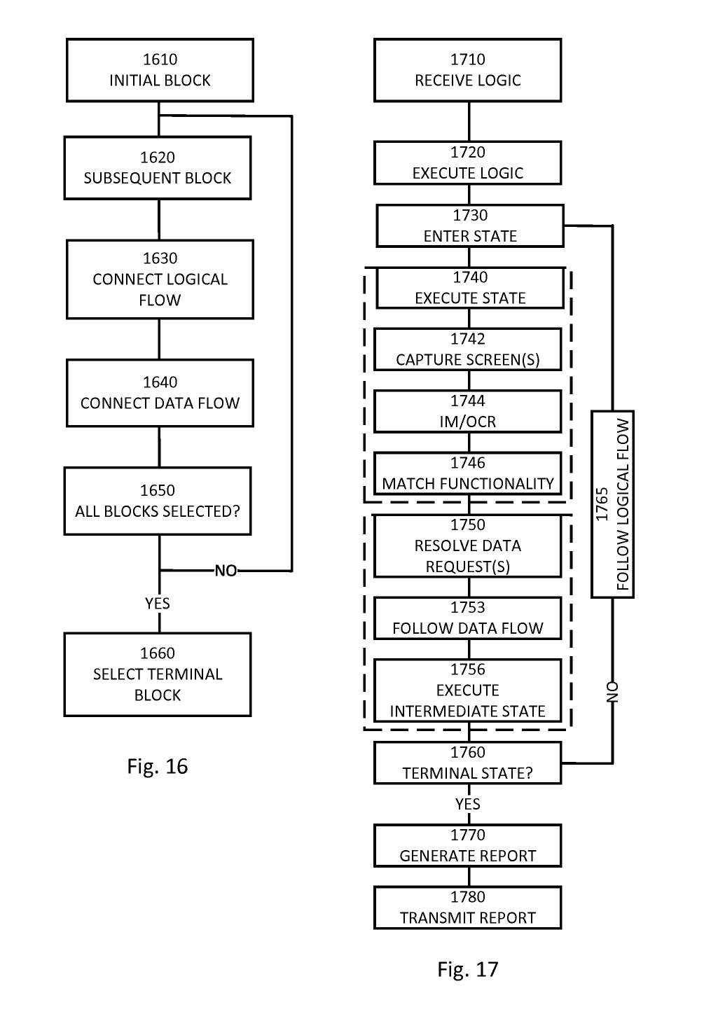

FIG. 16 shows a method for designing a test case or task to be automated using the visual tool. First an initial block is selected 1610, then a subsequent functional block is selected 1620 and logically connected 1630 to a previous block. Any data connections 1640 that need be made are specified by dragging a connector path from the requesting block to the providing port. Naturally, the data path may be drawn in the opposite direction also, but the logic of the data flow path is that the data is requested by the subsequent block, not pushed by the first block. This is repeated 1650 until all blocks have been selected and the logical flow terminates 1660 in a terminal block indicating a pass or fail. Each block in the design phase corresponds to a transformation or a state that could be traversed when executing the case logic.

FIG. 17 shows a method for executing a case having been designed using the visual tool. First the case logic (possibly already compiled) is received 1710 in a format that is readable by the system to be tested. The case logic is then executed or traversed 1720 by entering 1730 a state, the first being the initial state, corresponding to the initial block. As a state is entered, the state is handled 1740, which means that any functionality associated with the state is executed. When executing the state, any data requests need to be resolved 1750 which is done by following 1753 any corresponding data flow paths and possibly executing any intermediate state 1756 (corresponding to a transformation block). The dashed box indicates that more than one data flow path may need to be followed and also through more than one intermediate state.

Also, as the functionality of the state is executed, at least one screen capture is generated 1742 on which image recognition (IM) and/or optical character recognition (OCR) (or other text recognition) is performed 1744, possibly repeated (as indicated by the dashed box), for matching 1746 the functionality to the data being displayed on the screen.

As the state has been handled it is determined 1760 if it is a terminal state and if is not, a logical flow path is followed or traversed 1765 to a next state. The logical flow path chosen depends on the outcome of the state's execution (pass/fail). As a terminal state is reached a report is generated 1770 (instead of traversing to the next state) and transmitted 1780 to the controller, the report indicating whether the case was a pass or a fail, which is indicated by the terminal state. Possibly data is also requested by the terminal state, which data may be part of the report enabling automated tasks to supply data or test cases to provide informative data on the outcome of the test, apart from fail/pass.

As is to be understood, some steps may be executed in a reverse or changed order as to what has been disclosed herein.

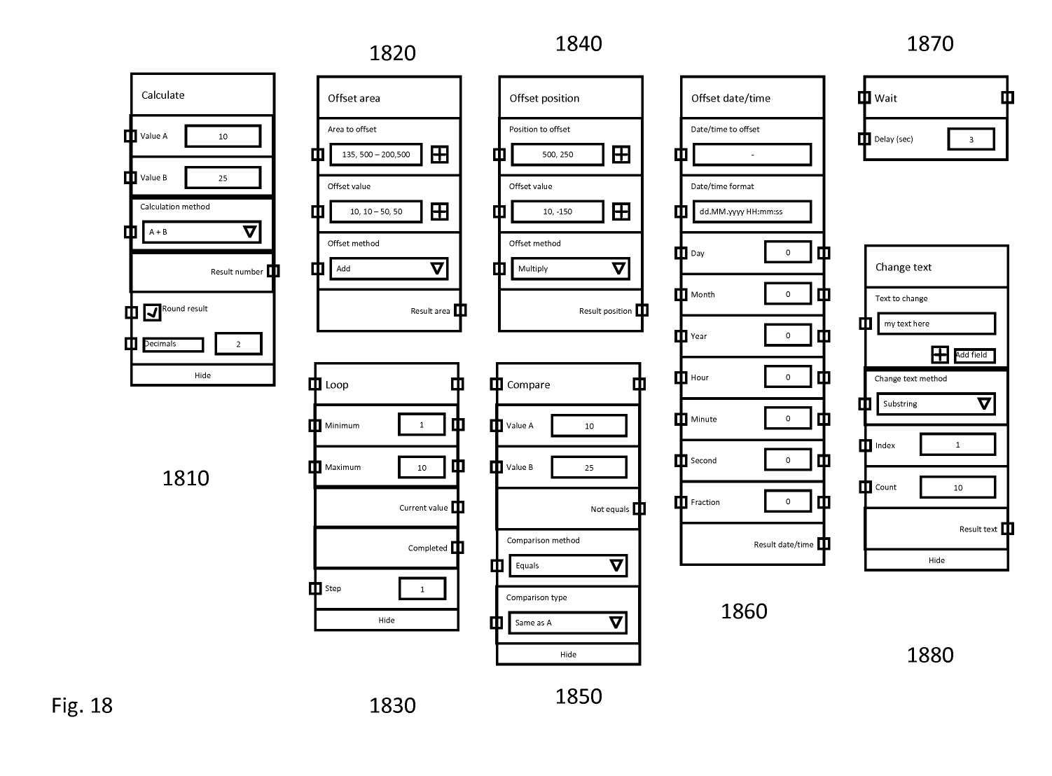

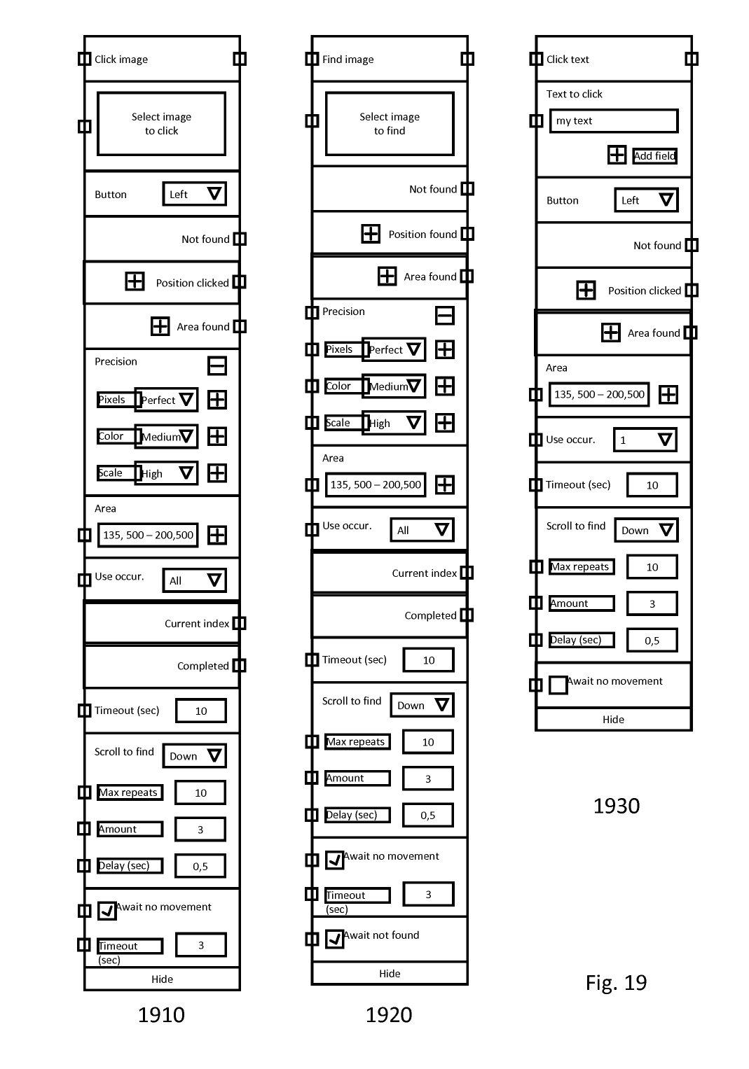

FIGS. 18 and 19 show examples of different process or building blocks that may be used when designing a case.

FIG. 18 shows basic blocks, whereof a first block 1810 has the associated function to calculate such as math, add, subtract, minus, multiply, divide, division and general arithmetic; a second block 1820 has the associated function to offset an area such as add, multiply, minus and subtract; a third block 1830 has the associated function to loop such as iterate and step; a fourth block 1840 has the associated function to offset a position such as add, multiply, minus and subtract, a fifth block 1850 has the associated function to compare such as equals, not equals, greater than, and less than; a sixth block 1860 has the associated function to offset a date/time such as change; a seventh block 1870 has the associated function to wait such as delay or suspend; and an eighth block 1880 has the associated function to change text, such as update text, substring, replace, concatenate, uppercase, lowercase, trim, index, length, and pad.

FIG. 19 show complex or combined blocks where a combined functionality is associated with the block. One example being that of the click image, where an image is specified and first it is found through image recognition and then a click is performed on the position where the image was found. The combined blocks allow for easier design as many steps may be represented by a single block. This simplification may also be provided for by the module concept discussed above with reference to FIGS. 12 and 13.

FIG. 19 also shows other examples whereof a first block 1910 has the associated function to click an image with the mouse specifying which click: left, right, middle; a second block 1920 has the associated function to find an image by recognizing it; and a third block 1930 has the associated function to click text with the mouse specifying which click: left, right, middle.

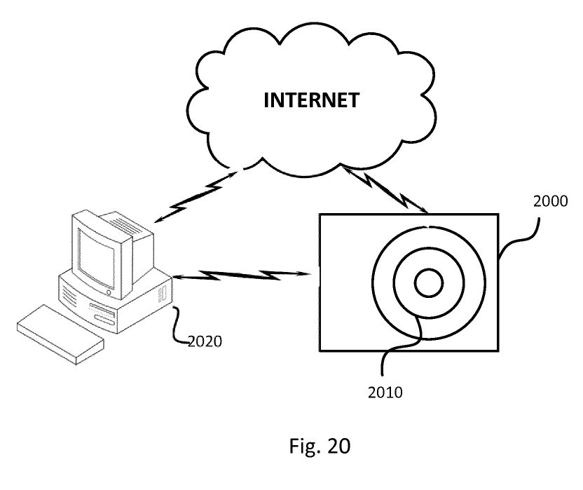

FIG. 20 shows a schematic view of a computer readable medium 2000 for storing computer software instructions 2010 associated with a functionality that when loaded into a processor of a device 2020 capable of reading the computer software instructions, such as the processor arrangement 910 of a computing apparatus 900 of FIG. 9, cause the functionality of the instructions to be executed. The computer readable medium may be tangible, such as in the form of optical discs, magnetic discs or flash memories to mention a few possibilities. The computer readable medium 2000 may be intangible, such as in the form of a signal, possibly radio frequency signal such as being transmitted using a communication standard such as Bluetooth™ Long Term Evolution, WiFi, Ethernet, Internet Protocol or other communication signal standard.

1. A computing apparatus comprising a processor arrangement and a memory, wherein said processor arrangement is configured to:
present a plurality of process blocks for selection;
receive a first selection of at least one of said plurality of process blocks and place a representation of said first selected at least one of said plurality of process blocks on a virtual canvas, wherein said first selected at least one of said plurality of process blocks is associated with a first functionality;
receive a second selection of at least one of said plurality of process blocks and place a representation of said second selected at least one of said plurality of process blocks on a canvas, wherein said second selected at least one of said plurality of process blocks is associated with a second functionality;
receive an indication of a process flow order between the first and second selection of at least one of said plurality of process blocks, and indicate the order graphically on the canvas; and
automatically generate computer readable instructions comprising instructions to execute the first functionality associated with the first selected at least one of said plurality of process blocks and the second functionality associated with the second selected at least one of said plurality of process blocks in the order as indicated by the indication of said process flow order,
thereby providing a case logic to be executed, which case logic is comprised in the computer readable instructions, wherein
at least one of said first and second functionalities is associated with a function of finding an associated graphical object by capturing a screen and performing image analysis (IR/OCR) on the screen capture to find the associated graphical object.

2. The computing apparatus according to claim 1, wherein said processor arrangement is further configured to:
receive an indication of a data flow between one of the first selected at least one of said plurality of process blocks and one of the second selected at least one of said plurality of process blocks and
automatically generate computer readable instructions comprising instructions to retrieve data and provide it to one of said selected process blocks in the order as indicated by the indication of the data flow.

3. The computing apparatus according to claim 1, wherein the logical direction of the process flow order is opposite the logical direction of the data flow.

4. The computing apparatus according to claim 1, wherein said processor arrangement is further configured to receive an indication that the first and second selections of at least one of said plurality of process blocks are to be grouped as one modular process block and automatically generate computer readable instructions comprising instructions to execute the first and second selections of at least one of said plurality of process blocks as one process block.

5. The computing apparatus according to claim 1, wherein one selected process block is an initial process block and another is a terminal process block whose associated function is to generate a report.

6. The computing apparatus according to claim 1, wherein at least one of the presented process blocks is associated with a combined functionality.

7. A method for designing a case logic to be executed, wherein said method comprises:
presenting a plurality of process blocks for selection;
receiving a first selection of at least one of said plurality of process blocks and place a representation of said first selected at least one of said plurality of process blocks on a virtual canvas, wherein said first selected at least one of said plurality of process blocks is associated with a first functionality;
receiving a second selection of at least one of said plurality of process blocks and place a representation of said second selected at least one of said plurality of process blocks on a canvas, wherein said second selected at least one of said plurality of process blocks is associated with a second functionality;
receiving an indication of a process flow order between the first and second selection of at least one of said plurality of process blocks, and indicate the order graphically on the canvas; and
automatically generating computer readable instructions comprising instructions to execute the first functionality associated with the first selected at least one of said plurality of process blocks and the second functionality associated with the second selected at least one of said plurality of process blocks in the order as indicated by the indication of said process flow order,
thereby providing a case logic to be executed, which case logic is comprised in the computer readable instructions, wherein
at least one of said first and second functionalities is associated with a function of finding an associated graphical object by capturing a screen and performing image analysis (IR/OCR) on the screen capture to find the associated graphical object.

8. A computer-readable medium configured to carry instructions that when loaded into the processor of a computing apparatus capable of reading the instructions cause a functionality associated with the instructions to be executed, wherein the instructions are configured to cause the execution of the method according to claim 7.

9. A computing apparatus comprising a processor arrangement and a memory, wherein said processor arrangement is configured to
receive a case logic as provided according to claim 1 and to transmit said case logic to a system to be tested causing the system to be tested to execute the case logic according to the computer readable instructions comprised in the case logic.

10. A method for use in a computing apparatus, said method comprising receiving a case logic as provided according to claim 1 and transmitting said case logic to a system to be tested causing the system to be tested to execute the case logic according to the computer readable instructions comprised in the case logic.

11. A computer-readable medium configured to carry instructions that when loaded into the processor of a computing apparatus capable of reading the instructions cause a functionality associated with the instructions to be executed, wherein the instructions are configured to cause the execution of the method according to claim 10.

12. A computing apparatus comprising a processor arrangement and a memory, wherein said processor arrangement is configured to
receive a case logic as provided according to claim 1 and to execute the case logic according to the computer readable instructions comprised in the case logic.

13. The computing apparatus according to claim 12, wherein said processor arrangement is further configured to
execute the case logic by
entering a first state, the first state corresponding to a first process block of said case logic;
executing the functionality associated with the process block corresponding to the state;
generate a screen capture;
causing said screen capture to be analyzed using image analysis (IR/OCR);
matching the analysis of the screen capture to the associated functionality; and
determining if the entered state is a terminal state, and, if so,
generating a report; and, if not,
following the logical flow as indicated by the case logic and entering a next state, the next state corresponding to a next process block of said case logic, and executing the functionality associated with the next process block corresponding to the state.

14. The computing apparatus according to claim 12, wherein the process block corresponding to the state is associated with a data request and wherein the processor arrangement is further configured to execute the functionality associated with the process block corresponding to the state by resolving the data request by requesting the data from a previous process block as indicated by a data flow comprised in the corresponding process block.

15. The computing apparatus according to claim 12, wherein the process arrangement is further configured to resolve the data request by executing an intermediate state as indicated by the data flow.

16. The computing apparatus according to claim 12, wherein the analysis is performed using image recognition.

17. The computing apparatus according to claim 12, wherein the analysis is performed using text recognition.

18. The computing apparatus according to claim 12, wherein the processor arrangement is further configured to execute the logical process flow in a first logical direction and to execute the data flow in an opposite logical direction.

19. A method for use in a computing apparatus, wherein said method comprises
receiving a case logic as provided according to claim 1, and executing the case logic according to the computer readable instructions comprised in the case logic.

20. The method according to claim 19, wherein said method further comprises
executing the case logic by:
entering a first state, the first state corresponding to a first process block of said case logic;
executing the functionality associated with the process block corresponding to the state;
generating a screen capture;
causing said screen capture to be analyzed using image analysis (IR/OCR);
matching the analysis of the screen capture to the associated functionality; and
determining if the entered state is a terminal state, and, if so,
generating a report; and, if not,
following the logical flow as indicated by the case logic and entering a next state, the next state corresponding to a next process block of said case logic, and executing the functionality associated with the next process block corresponding to the state.

21. A computer-readable medium configured to carry instructions that when loaded into the processor of a computing apparatus capable of reading the instructions cause a functionality associated with the instructions to be executed, wherein the instructions are configured to cause the execution of the method according to claim 19.
